(19) United States
(12) Patent Application Publication
(10) Pub. No.: US 2022/0257037 A1
(43) Pub. Date: Aug. 18, 2022

(54) A PAPER STRAW COMPRISING A FLEXIBLE PORTION

(71) Applicant: Billerudkorsnas AB, Solna (SE)

(72) Inventors: Emma Hellqvist, Solna (SE); Ilesh Mawji, Bolton (GB); Rakesh Patel, Bolton (GB); Geert Pijper, Bolton (GB)

(21) Appl. No.: 17/626,108

(22) PCT Filed: Jul. 8, 2020
(86) PCT No.: PCT/EP20/69243

§ 371 Date: Jan. 10, 2022

(30) Foreign Application Priority Data
Jul. 11, 2019 (EP) 19185728.3

(51) Int. Cl. A47G 21/18; B31D 5/00

(52) U.S. Cl. CPC A47G 21/186; B31D 5/0095

(57) ABSTRACT

The present disclosure generally relates to a paper straw comprising a flexible portion having a compressed and an extended state, wherein the paper straw comprises a stretchable paper. The disclosure also relates to a drinking kit comprising the paper straw and to a process and a machine equipment for manufacturing the paper straw.

### TECHNICAL FIELD

The present disclosure generally relates to a paper straw comprising a flexible portion having a compressed and an extended state, wherein the paper straw comprises a stretchable paper. The disclosure also relates to a drinking kit comprising the paper straw and to a process and a machine equipment for manufacturing the paper straw.

### BACKGROUND

Packaged individual beverage containers have been on the market for many years. Such beverage containers typically comprise a liquid container, e.g. a disposable liquid box, and a straw packaged in a separate sealed plastic envelope attached to the liquid container. In use, the consumer removes the drinking straw from the envelope and inserts it through the liquid box at a predetermined position, typically at a sealed aperture on the top of the box. The consumer may puncture the sealed aperture using the bottom of the straw to thereby gain access to the stored liquid in the container.

In order to consume the beverage, the straw needs to be long enough; i.e. the straw must have a length substantially larger than the length of the box. During drinking, the lower portion of the straw may touch the bottom of the package, but the upper portion of the straw is bent to enable consumption by a user.

The fact that the length of the straw is larger than the box typically requires the straws to be packed in a u-shaped configuration.

Currently, u-shaped plastic straws are available on the market for disposable beverage containers. However, plastic straws are presently being banned due to environmental concerns. There is therefore a need to provide a more environmental solution to replace u-shaped plastic straws.

Paper straws have gained attention recently, but suffer from limitations relating to collapsing and breakage of the straw during bending and during manufacturing. Paper straws are therefore typically available in a generally straight configuration.

Attempts have been made to provide bendable paper straws, and such attempts typically include the formation of radially extending scores formed from e.g. removal of sidewall material in the upper portion of the straw.

For example, US2019/0069701, discloses such a paper straw.

Prior art paper straws are typically only slightly bendable; i.e. only bendable at small angles, but are not allowed to be bent into a u-shape. Furthermore, prior art paper straws are not extendable and therefore not suitable for being bent into a u-shape. In doing so, the paper of the straw will collapse or break.

Thus, there is a need to provide a paper straw that allows for repeated bendings, and for bending the straw into a u-shape. Such a paper straw should be suitable for packaging with a corresponding liquid container. Furthermore, means for providing such paper straws are also desired.

### SUMMARY OF THE INVENTION

In view of the above mentioned and other drawbacks of the prior art, it is an object of the present disclosure to provide improvements with respect to paper straws, particularly with respect to their ability to bend into a curvilinear configuration, such as a u-shape, as well as means to provide such paper straws.

According to a first aspect of the present disclosure, there is provided a paper straw comprising a lower portion, an upper portion, and a flexible portion arranged between the lower and upper portions, wherein the flexible portion has a compressed state and an extended state, wherein the length of the straw is larger in the extended state compared to the compressed state, wherein the paper straw comprises a paper having a stretchability according to ISO 1924-3:2005 of at least 6% in the machine direction (MD) and at least 6% in the cross direction (CD).

The inventors have found that by utilizing a stretchable paper, a paper straw having similar bending and extensibility properties as a corresponding plastic straw, may be achieved.

In other words, the paper straw of the present disclosure combines the advantages associated with plastic straws, and with environmentally friendly paper straws.

The paper straw according to the present disclosure comprises a flexible portion which may be reversibly moved from an extended to a compressed state and which allows the straw to be bent into a curvilinear shape, such as a u-shape.

The paper straw may thus be packed together with, or attached to, a liquid container, such as a disposable liquid box in a similar manner as present drinking kit solutions involving plastic straws.

The paper of the paper straw is tolerable to the forces imparted during manufacturing of the flexible portion, which typically involve the formation of corrugations in the sidewalls of the paper straw. Conventional paper straws have a tendency to break during this critical part of the manufacturing process. In other words, the paper straw of the present disclosure is resistant to breakage and collapsing during manufacturing.

The paper straw can be arranged in a straight configuration and in a curvilinear configuration, wherein in the straight configuration, the paper straw has a rotational symmetry with respect to a longitudinal axis, Z, and wherein in the curvilinear configuration, the angle between the end point of the upper portion of the paper straw and the longitudinal axis, Z, is from 130 to 180 degrees.

In other words, the paper straw may be substantially reversibly moved from a straight configuration into a curvilinear configuration, suitable for packaging purposes. Depending on the size of the liquid box to which the straw is to be attached, the paper straw may be attached thereto in a curvilinear configuration at large angles; i.e. from 130 to 180 degrees.

This, of course, have advantages for the users consuming liquids by means of the paper straw. For example, children consuming beverages such as juice or lemonade, typically have a tendency to bend the straw several times in several directions both during drinking but also for the purpose of playing.

Preferably, the paper straw can be arranged in a straight configuration and in a substantially u-shaped configuration.

In embodiments, the stretchability according to ISO 1924-3:2005 is at least 9% in at least one of the machine direction (MD) and the cross direction (CD).

This further improves the flexibility, extensibility and the ability to bend the paper straw at large angles.

A high tensile strength (i.e. a high maximum force that a paper can withstand before breaking), is also desired for the paper used in the paper straw according to the present disclosure. Tensile energy absorption (TEA) is sometimes considered to be the paper property that best represents the relevant strength of a paper. The tensile strength is one parameter in the measurement of the TEA and another parameter is stretchability.

In embodiments, the paper has a tensile energy absorption index according to ISO 1924-3:2005 of at least 3.5 J/g in the machine direction (MD) and/or at least 2.9 J/g in the cross direction (CD).

In embodiments, the paper has a Gurley porosity according to ISO 5636-5 above 15 s, preferably above 20 s.

In other words, a paper having a high stretchability and a low porosity is preferably used, and allows the paper to withstand the forces imparted during manufacturing, particularly during the formation of the flexible region of the paper straw.

In embodiments, the paper straw of the present disclosure has a grammage of from 250 to 500 gsm, preferably from 280 to 360 gsm.

If the basis weight of the paper straw is too low; i.e. below 250 g/m2, the paper straw may collapse or break during manufacturing, particularly during the formation of the flexible portion. However, the basis weight should not be too high as the paper straw may become too thick and rigid and thereby unsuitable for consuming liquids by a user. A too thick straw may also impair the ability of the straw to bend at large angles.

In embodiments, the paper straw comprises from 2 to 5 plies of paper, preferably from 3 to 4 plies of paper.

The number of plies used is dependent on the basis weight; i.e. grammage, of each of the paper plies. In other words, the paper straw may comprise 4-5 relatively thin paper plies, or 2 thicker paper plies. Preferably 3 plies of paper are used. This is beneficial from a production point of view; i.e. to allow for the formation of the flexible portion of the straw.

Furthermore, the lower portion of the straw that is to be inserted into a liquid container needs to be rigid and stable enough without becoming soggy during extraction of liquid from the container. The same applies to the upper portion of the straw which is to be exposed for drinking purposes.

For the purpose of consuming liquid from a container, such as a disposable liquid box, and also for the purpose of allowing the straw to be packed in conjunction with a container, the paper straw is preferably dimensioned to fit such purposes. In other words, the straw is preferably relatively thin.

In exemplary embodiments of the present disclosure, the outer diameter of the paper straw is from 3 to 7 mm, preferably from 4 to 6 mm.

The thickness of the sidewalls of the paper straw may be from 0.2 to 1.5 mm, preferably from 0.3 to 0.8 mm.

These dimensions allow the user to develop sufficient suction to move a liquid through the straw against the forces of gravity, and allows the paper straw to be conveniently packaged and used together with a liquid container.

In embodiments, the length the flexible portion in the extended state corresponds to from 8 to 20% of the length of the paper straw in the extended state.

The paper straw may thus be conveniently extended, and also bent into a u-shape. If the flexible portion is too short, the ability to extend and bend the paper straw is impaired. A too large flexible portion may be undesired from a design and consumer point of view.

In embodiments, the length of the straw in the extended state is at least 10% larger than the length of the straw in the compressed state.

Accordingly, the paper straw may be formed in and retain a curvilinear shape.

In embodiments, the flexible portion comprises from 8 to 14 corrugated sections, preferably from 10 to 12 corrugated sections formed from the sidewalls of the paper straw.

This way, the paper straw can be appropriately extended and bent at large angles; i.e. up to 180 degrees.

In embodiments, at least a surface of the paper straw comprises a liquid impermeable coating.

This is beneficial to prevent the paper straw from becoming soggy or from collapsing during repeated liquid suctions.

According to second aspect of the present disclosure, a drinking kit comprising a liquid container, such as a disposable liquid box, and the paper straw as described hereinbefore is provided.

The paper straw may be attached to an outer surface of the liquid container in a substantially u-shaped configuration.

According to a third aspect of the present disclosure, a machine equipment for manufacturing a paper straw is provided. The machine equipment comprises:

a) means for providing an elongated paper tube
b) means for cutting the elongated paper tube into a plurality of shorter paper tubes
c) means for forming a flexible portion in the paper tubes, wherein the means for forming the flexible portion comprises:
a first set of mandrels, wherein at least one mandrel of the first set of mandrels comprises a tip and a base, and a structured portion arranged between the tip and the base,
a second set of mandrels arranged opposite of and at a distance from the first set of mandrels, wherein the mandrels of the first and second sets of mandrels are arranged to enter the paper tube from opposite directions
an elongated plate having a surface portion corresponding to and arranged to contact the structured portion of the mandrel(s) of the first set of mandrels,
   wherein at least one of the mandrels of the first set of mandrels has a rotational symmetry with respect to a longitudinal axis, Z, and wherein the structured portion comprises at least a first circumferential protrusion defined between a first and a second recessed portion,
   wherein the first protrusion(s) has a first sidewall extending from the first recessed portion to an edge point of the first protrusion at an angle, α, with respect to the longitudinal axis, Z, of between 45 and 60 degrees and a second sidewall extending from the second recessed portion to the edge point of the first protrusion at an angle, β, of between 80 and 90 degrees.

The angular dimensions of the protrusion(s) are important in the formation of a paper straw being extensible and being able to move between a compressed and extended state. If the angle, β, is larger than 90 degrees, the paper straws may be teared, and subject to breaking during compression of the straws.

The machine equipment of the present disclosure combines the advantages with machines used for forming paper straws, and plastic straws, respectively.

The edge point of the protrusion of the structured portion of the mandrel may be relatively sharp, and the paper used in conventional paper straws will typically break or tear in forming such a flexible portion.

However, the paper used in the paper straw of the present disclosure has the ability to resist the forces implied during manufacturing.

The maximum outer diameter of the protrusion corresponds to the diameter of the mandrel of the first set of mandrels.

A paper tube can therefore slide through the entire length of the mandrel, and the flexible portion is formed where the structured portion of the mandrel is arranged. This is achieved by the contact submitted between the structured portion of the mandrel(s) and the elongated plate which has a surface that corresponds to the pattern of the structured portion.

In embodiments, at least one mandrel of the first set of mandrels comprises from 8 to 13 circumferential protrusions, preferably from 10 to 11 circumferential protrusions, and from 9 to 14 recessed portions, preferably from 11 to 12 recessed portions.

This allows for a sufficiently long flexible portion to be formed in the paper straw, and allows the straw to be extended between a compressed and an extended state. Furthermore, it allows the paper straw to be bent into a u-shape.

In embodiments, at least one mandrel of the second set of mandrels is arranged to be pushed against at least one oppositely arranged mandrel of the first set of mandrels such that a paper tube arranged on the mandrel of the first set of mandrels is subject to endwise compression.

Accordingly, the paper tube will be compressed simultaneously with the elongated plate being in contact with the corrugated structure of the mandrels. This way, a “shape memory” of the flexible portion is formed, which allows the flexible portion to move between an extended and compressed state in a repeated manner.

The machine equipment used to form the paper straws of the present disclosure needs to be able to provide paper straws of small diameters, e.g. paper straws having a diameter of from 3 to 7 mm, e.g. from 4 to 6 mm. Such “thin” paper straws can typically not be formed by conventional paper straw machines.

Thus, in embodiments, the means for providing an elongated tube in line with step a) above comprises:
a pin onto which 2 to 5 plies of paper may be winded to form a paper tube
a heating element extending between an open inlet portion and an open outlet portion, wherein the heating element is arranged at a distance of from 10 to 50 cm, preferably from 25 to 40 cm from the tip of the pin.

In conventional means for providing an elongated paper tube, plies of paper are wound about a long, extending pin. The tube is thereafter cut into length with the pin inside the elongated paper tube. The cutting means typically comprise multiple blades which press against the paper tube and the pin arranged therein such that multiple paper tubes of shorter length may be produced at the same time.

Such cutting means are unsuitable for use in the formation of paper tubes of small diameters (e.g. below 7 mm) since such thin tubes are particularly sensitive to collapsing. Furthermore, the underlying pin may become damaged or scratched by the multiple blades.

Instead, the inventors have found an improved, and more gentle means for providing thin paper tubes, and also for cutting such thin paper tubes.

According to the present disclosure, the paper straws are wound around a pin as in conventional means to provide an elongated paper tube. However, the pin is relatively short such that only a part of the elongated tube will embrace the pin. A heating element is arranged at a distance of 10 to 50 cm, e.g. 25 to 40 cm from the tip of the pin. Accordingly, the winding of the paper plies will continue without the support of an elongated pin. A straight elongated paper tube is thus formed “in the air” between the heating element and the pin.

The temperature of the heating element may be from 50-70° C. This allows for the paper to dry prior to cutting the tube.

In embodiments, the means for cutting the elongated paper tube comprises a rotatable single knife.

When the elongated paper tube exits from the heating element, the paper tube is cut, by means of the rotatable single knife, through the entire cross section of the elongated paper tube.

A more gentle cutting means is thereby provided, particularly suitable for paper straws of small diameters.

According to another aspect of the present disclosure, a process for manufacturing a paper straw comprising a lower portion, an upper portion, and a flexible portion arranged between the lower and upper portions is provided. The process comprises:

a) providing an elongated paper tube comprising a paper having a stretchability according to ISO 1924-3:2005 of at least 6% in the machine direction (MD) and at least 6% in the cross direction (CD)
b) cutting the paper tube into plurality of shorter paper tubes
c) forming a flexible portion in at least one of the paper tubes, wherein the flexible portion has a compressed state and an extended state, wherein the length of the straw is larger in the extended state compared to said compressed state.

Further features of, and advantages with, the present disclosure will become apparent when studying the appended claims and the following description. The skilled addressee realizes that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 illustrates a paper straw according to the prior art.

FIG. 2a illustrates a paper straw according to the present disclosure in a straight, compressed state.

FIG. 2b illustrates a paper straw according to the present disclosure in a straight, extended state.

FIG. 2c illustrates a paper straw according to the present disclosure in a curvilinear, i.e. u-shaped configuration.

FIG. 3 illustrates a drinking kit comprising a liquid container and a paper straw according to the present disclosure.

FIG. 4a schematically illustrates the interior of the means for forming a flexible portion in the paper straws of the present disclosure.

FIG. 4b is a cross-sectional side view of the elongated plate used in in the means of FIG. 4a.

FIG. 4c is a cross-sectional side view of the mandrel used in the means of FIG. 4a.

FIG. 5a is a perspective view of the means for providing an elongated paper tube and cutting the elongated paper tube into a plurality of shorter paper tubes according to the present disclosure.

FIG. 5b is a side view of the means of FIG. 5a.

FIG. 5c illustrates the single rotational knife of the cutting means of FIGS. 5a and 5b.

FIG. 6 schematically illustrates the process by which the paper straw may be produced according to the present disclosure.

### DETAILED DESCRIPTION

The present disclosure will now be described more fully hereinafter with reference to the accompanying drawings, in which currently preferred embodiments of the present disclosure are shown. The present disclosure may, however, be embodied in many different forms and should not be construed as limited to the embodiments set forth herein; rather, these embodiments are provided for thoroughness and completeness, and fully convey the scope of the present disclosure to the skilled person.

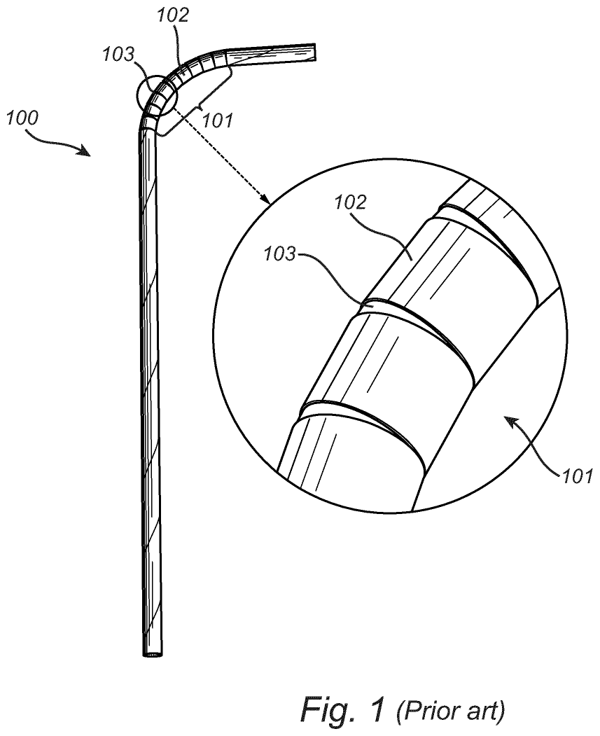

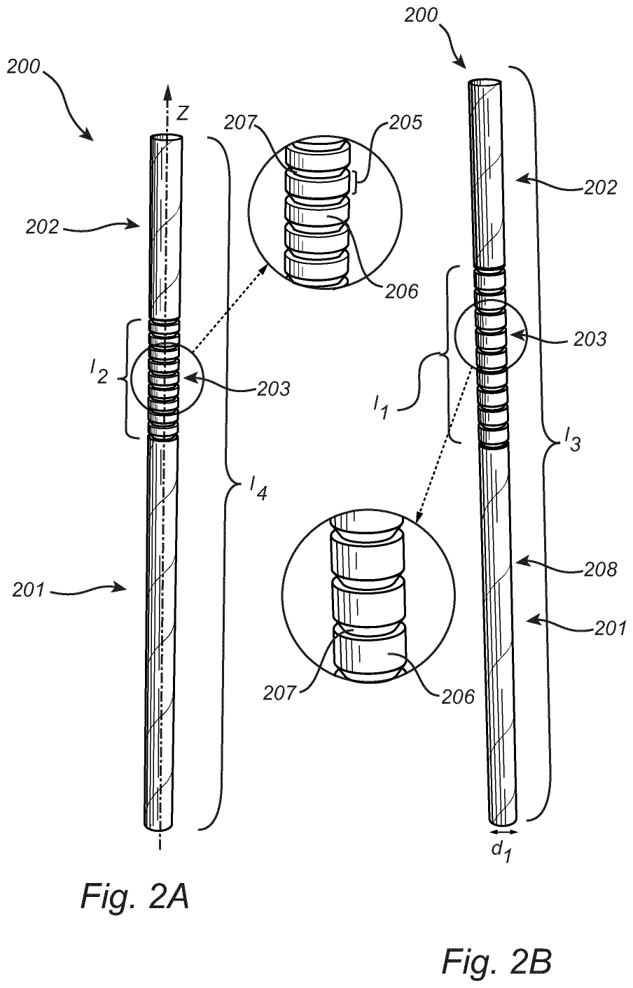

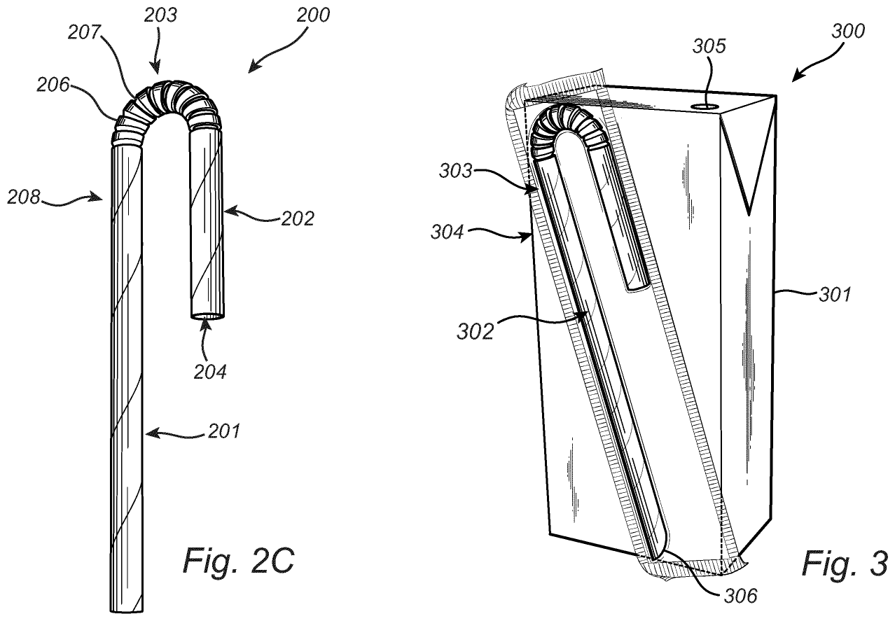

In FIG. 1, a paper straw 100 according to the prior art is disclosed. The paper straw 100 comprises a slightly bendable portion 101. The portion 101 comprises a plurality of segmented side wall sections 102 defined between a plurality of annular grooves 103. The paper straw 100 according to prior art is not extensible between a compressed and extended state and is only bendable at small angles with respect to the length direction of the straw. In FIGS. 2a-2c, a paper straw 200 according to the present disclosure is illustrated. The paper straw 200 comprises a lower portion 201, an upper portion 202, and a flexible portion 203 arranged between the lower 201 and upper 202 portions, wherein the flexible portion 203 has a compressed state (as illustrated in FIG. 2a) and an extended state (as illustrated in FIG. 2b); the length of the straw 200 being larger in the extended state compared to the compressed state, wherein the paper straw 200 comprises a paper having a stretchability according to ISO 1924-3:2005 of at least 6% in the machine direction (MD) and at least 6% in the cross direction (CD).

In the context of the present disclosure, the lower portion 201, upper portion 202, and flexible portion 203, respectively, are formed from the same paper. In other words, the lower portion 201, upper portion, and the flexible portion 203 are integral with each other. Typically, an elongated paper tube is first formed, and the flexible portion 203 is thereafter formed in the (non-corrugated) paper tube. In other words, the portions of the paper straw of the present disclosure are not formed from separate components, which are subsequently attached (e.g. by means of gluing) to each other. Such a construction would not be suitable from a stability point of view or from a consumer point of view.

In the context of the present disclosure, the lower portion 201, upper portion 202, and flexible portion 203 comprise a paper having a stretchability according to ISO 1924-3:2005 of at least 6% in the machine direction (MD) and at least 6% in the cross direction (CD).

The paper straw 200 can be arranged in a straight configuration and in a curvilinear configuration (illustrated in FIG. 2c), wherein in the straight configuration, the paper straw 200 has a rotational symmetry with respect to a longitudinal axis, Z, and wherein in the curvilinear configuration, the angle between the end point 204 of the upper portion 202 of the paper straw 200 and the longitudinal axis, Z, is from 130 to 180 degrees. In FIG. 2c, the paper straw has a u-shaped configuration, and the angle between the end point 204 of the upper portion 202 of the paper straw 200 and the longitudinal axis, Z, is 180 degrees.

The paper straw 200 of the present disclosure is environmentally friendly, and entails similar advantages with respect to bendability and flexibility as a traditional plastic straw. The paper straw 200 of the present disclosure thus represents a promising and commercially viable solution to replace plastic straws on the market.

Preferably, the paper straw 200 can be arranged in a straight configuration and in a substantially u-shaped configuration (as illustrated in FIG. 2c).

The paper straw 200 comprises a stretchable paper; i.e. a paper having a stretchability according to ISO 1924-3:2005 of at least 6% in the machine direction (MD) and at least 6% in the cross direction (CD).

Preferably, the stretchability according to ISO 1924-3:2005 is at least 7% in the machine direction (MD) and at least 7% in the cross direction (CD).

In embodiments, the paper has a stretchability according to ISO 1924-3:2005 of at least 9% in at least one of the machine direction (MD) and the cross direction (CD).

The paper may have a stretchability in MD or CD of at least 10% or at least 11%.

Preferably the paper is stretchable in both MD and CD. An upper limit for the stretchability in MD may for example be 20 percent or 25 percent. An upper limit for the stretchability in CD may for example be 15 percent.

The stretchability (in both MD and CD) is determined according to the standard ISO 1924-3:2005.

In embodiments, the tensile energy absorption (TEA) index of the paper according to ISO 1924-3:2005 is at least 3.5 J/g in the machine direction (MD) and/or at least 2.9 J/g in the cross direction (CD).

For example, the TEA index may be from 3.5 to 7.5 J/g in the machine direction (MD) and from 2.9 to 3.9 in the cross direction (CD).

The tensile strength and the tensile energy absorption (TEA) index of the paper are preferably high in the paper of the paper straw 200. The tensile strength is the maximum force that a paper will withstand before breaking. In the standard test ISO 1924-3, a stripe having a width of 15 mm and a length of 100 mm is used with a constant rate of elongation. Tensile energy absorption (TEA) is sometimes considered to be the paper property that best represents the relevant strength of a paper. The tensile strength is one parameter in the measurement of the TEA and another parameter is stretchability. The tensile strength, the stretchability and the TEA value are obtained in the same test. The TEA index is the TEA value divided by the grammage. In the same manner, the tensile index is obtained by dividing the tensile strength by the grammage.

In embodiments, the paper has a Gurley porosity according to ISO 5636-5 above 15 s, preferably above 20 s.

In contrast to many sack papers, which may be highly stretchable, the paper of the present disclosure is not particularly porous. Instead, relatively low porosity may be preferred. For example, in embodiments where the paper straw comprises a coating, such as a liquid impermeable coating, the coating has a lower tendency to bleed through a paper of low porosity.

The air resistance according to Gurley, i.e. the Gurley porosity, is a measurement of the time (s) taken for 100 ml of air to pass through a specified area of a paper sheet. Short time means highly porous paper.

The Gurley porosity of the paper of the present disclosure may be above 15 s, preferably above 20 s.

In embodiments, the Gurley porosity of the paper is at least 25 s, such as at least 35 s. An upper limit may for example be 120 s or 150 s. The Gurley porosity is determined according to ISO 5636-5.

The pulp used to form the paper of the paper straw may comprise a sulphate pulp.

The pulp used to form the paper of the present disclosure may be a virgin pulp, such as a sulphate pulp (sometimes referred to as a “kraft pulp”), which provides high tensile strength. Accordingly, the paper of the present disclosure is preferably a kraft paper.

For the same reason, the starting material used for preparing the pulp preferably comprises softwood (which has long fibers and forms a strong paper).

Accordingly, the pulp used to form the paper of the present disclosure may comprise at least 50% softwood pulp, preferably at least 75% softwood pulp and more preferably at least 90% softwood pulp. The percentages are based of the dry weight of the pulp. Preferably, the paper of the present disclosure is a softwood kraft paper formed from 100% virgin fibers.

The paper used in the paper straw 200 of the present disclosure may be produced according to a process disclosed in WO2018/185213, WO2018/185215 or WO2018/185216, the entire contents of which are incorporated herein by reference.

The paper used in the paper straw 200 is preferably a paper commercialized by BillerudKorsnäs under the trademark FibreForm®.

In embodiments, the paper straw 200 has grammage of from 250 to 500 gsm, preferably from 280 to 360 gsm.

The grammage, or the basis weight of the paper may be measured according to the standard ISO 536:2012.

In embodiments, the paper straw comprises from 2 to 5 plies of paper, preferably from 3 to 4 plies of paper.

The number of plies used is dependent on the basis weight of each of the plies. In other words, the paper straw may comprise 4-5 relatively thin paper plies, or 2 thicker paper plies. Preferably 3 plies of paper are used. Each of the paper plies may have a grammage from of 50-200 g/m², preferably 60-160 g/m² and more preferably 70-120 g/m².

The paper straw of the present disclosure is first formed by winding 2-5 plies of paper to form a paper tube, and the flexible portion is thereafter formed in the paper tube.

The paper of the present disclosure is preferably white. For example, its brightness according to ISO 2470-1:2016 may be at least 80%, such as at least 82%.

However, the paper may also be unbleached (“brown”) or colored.

In embodiments, the paper straw 200 may comprise a print covering at least a portion of the straw.

The paper straw 200 is preferably thin to allow for package and utilization together with a liquid container.

In embodiments, the outer diameter, d₁, of the paper straw is from 3 to 7 mm, preferably from 4 to 6 mm.

The sidewalls 208 of the paper straw 200 may comprise from 2 to 5, preferably from 3 to 4 helically wound plies of paper.

The thickness of the sidewalls 208 of the paper straw may be from 0.2 to 1.5 mm, preferably from 0.3 to 0.8 mm. More preferably, the thickness of the sidewalls 208 is from 0.4 to 0.6 mm.

These dimensions are beneficial from a consumer point of view, and also from a packaging perspective.

In embodiments, the length, l₁ the flexible portion 203 in the extended state corresponds to from 8 to 20% of the length of the paper straw, l₃ in the extended state.

The length of the straw 200 (and of the flexible portion) may vary depending on the application or depending on the size of a liquid container to which the straw is to be attached.

For example, the length, l₃, of the straw may be between 8 and 25 cm, preferably between 12 and 18 cm.

The length, l₁, of the flexible portion in the extended state may be 0.7 to 5 cm, preferably 0.9 to 3.5 cm.

In embodiments, the length, l₃, of the straw 200 in the extended state is at least 10% larger than the length, l₄, of the straw in the compressed state.

For example, the length, l₃, of the straw 200 in the extended state may be at least 15% or at least 20% larger than the length, l₄, of the straw in the compressed state.

Accordingly, the paper straw may be formed in, and also retain, a curvilinear shape.

The extensibility of the straw allows the consumer to bend the straw into a variety of angles.

The flexible portion 203 preferably comprises from 8 to 14 corrugated sections 205, preferably from 10 to 12 corrugated sections 205 formed from the sidewalls 208 of the paper straw 200.

As used herein, the term “corrugated section” means an intermediate material portion 206 defined between two annular grooves 207. The intermediate material portion is a folded piece of material formed from the sidewalls 208 of the paper straw 200, and which is allowed to extend from a compressed state to an extended state.

The diameter of paper straw 200 in the groove 207 may be at least 20%, preferably at least 25% less than the diameter of the diameter of the intermediate material portion 206; i.e. the diameter of the straw 200.

A paper straw having at least 8, preferably at least 10 corrugated sections may extend in the longitudinal direction of the straw, and may also be bent at large angles; i.e. up to 180 degrees.

The flexible portion 203 is typically arranged above the central point of the straw 200.

For example, the lower portion 201 of the paper straw 200 may have a length corresponding to at least 60% of the longitudinal extension of the straw.

The flexible portion 203 may have a length corresponding to at least 13% of the longitudinal extension of the paper straw 200.

The upper portion 202 may have a length corresponding to at least 27% of the straw 200.

In embodiments, at least a surface of the paper straw 200 comprises a liquid impermeable coating.

For example, the paper may be coated with a liquid impermeable coating prior to the formation of the paper straw 200.

The coating may be a liquid impermeable ink. The ink prevents the paper from absorbing liquid and thereby become soggy or collapsed during use. It may also serve the purpose of masking the “taste” of paper.

The fact that the paper straw is both extensible and bendable into a u-shape allows the straw to be packed and utilized together with a liquid container.

In FIG. 3, a drinking kit 300 according to a second aspect of the present disclosure is illustrated.

The drinking kit 300 comprises a liquid container 301, such as a disposable liquid box, and the paper straw 302 as described hereinbefore.

The present disclosure is not limited to a particular shape or size of the liquid container 301, but is particularly advantageous for disposable, single-serving disposable containers, such as carton boxes comprising a beverage or any type of liquid consumable.

The paper straw 302 may be packaged in a separate sealed plastic envelope 303 and attached to the liquid container 301.

The paper straw 302 may be attached to an outer surface 304 of the liquid container 301 in a curvilinear configuration, preferably in a u-shaped configuration.

This u-shaped configuration is typically accompanied by elongation of the flexible portion, or at least parts of the flexible portion 203 of the straw.

The liquid container 301 may comprise an opening 305, e.g. a sealed opening into which the straw 302 is to be inserted during consumption. Such an opening 305 may be arranged at a top portion of the container 301.

The user may puncture the sealed aperture 305 using the bottom surface 306 of the straw 302 to gain access to the stored beverage within the container 301.

The bottom surface of the straw 306 may be cut at an angle to create a sharp tip to facilitate puncture of the aperture 305.

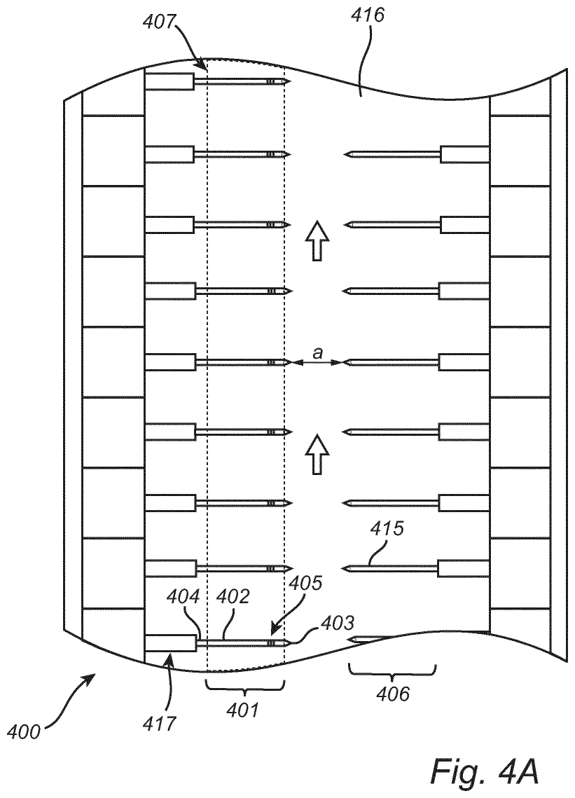

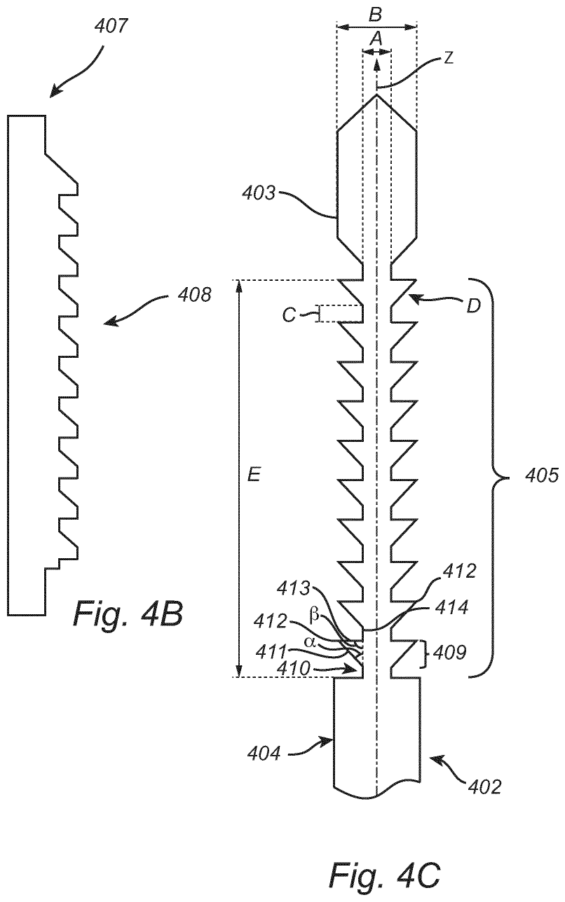

In FIGS. 4-7, a third aspect of the present disclosure is illustrated; i.e. means and components comprised within the machine equipment for manufacturing a paper straw as described hereinbefore.

As used herein the term “machine equipment” may involve one or more machines. Typically, the manufacture of the straw takes place on several machines.

The means for forming a flexible portion in the paper straw is schematically illustrated in FIG. 4a-c.

The machine equipment comprises:

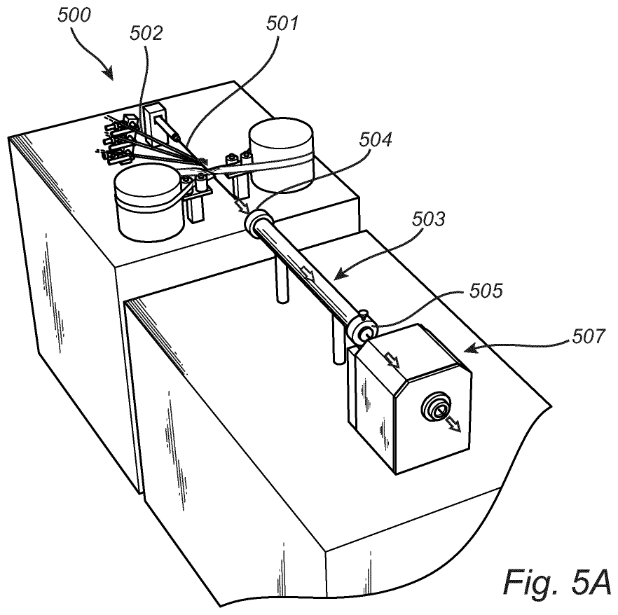

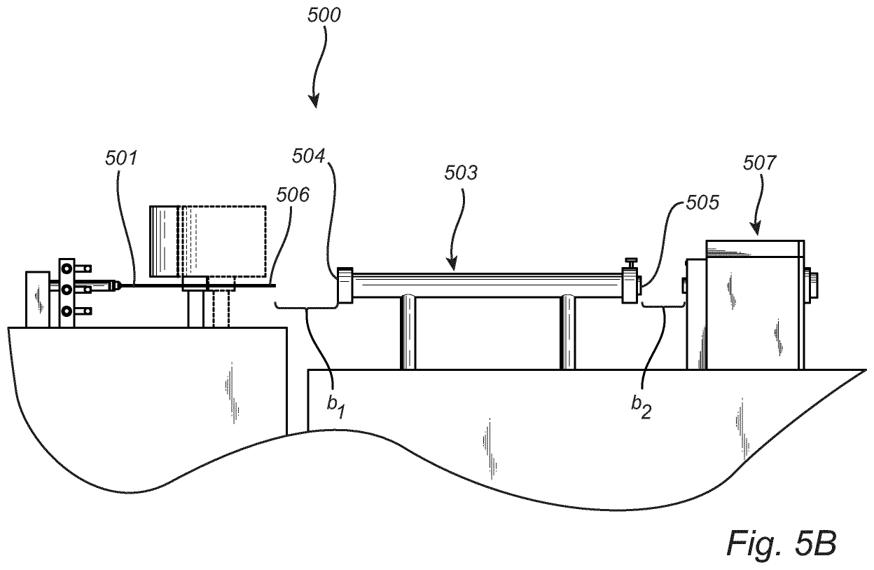

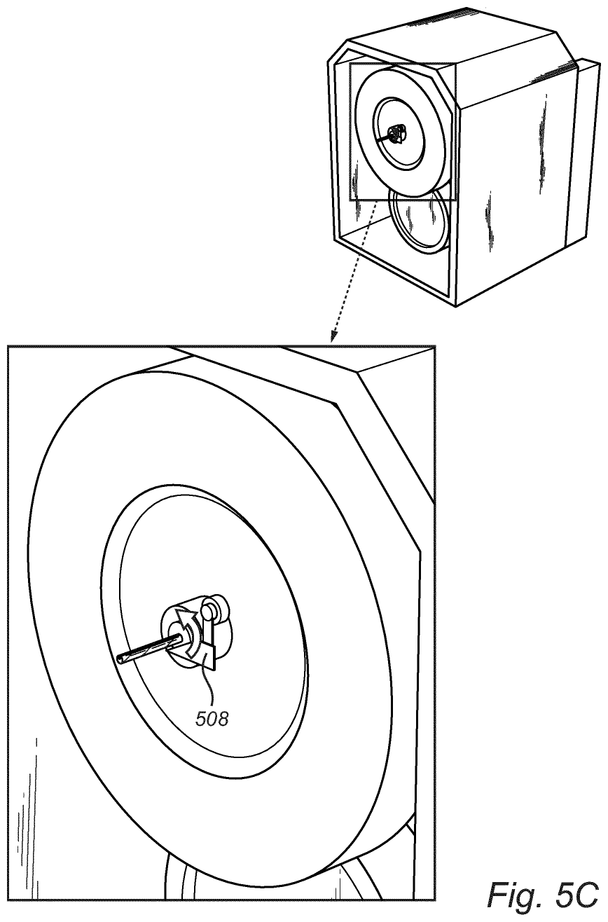

a) means for providing an elongated paper tube (see FIGS. 5a and 5b)
b) means for cutting the elongated paper tube into a plurality of shorter paper tubes (see FIG. 5c)
c) means 400 for forming a flexible portion 203 in the paper tubes, wherein the means for forming the flexible portion 203 comprises:
a first set of mandrels 401, wherein at least one mandrel 402 of the first set of mandrels 401 comprises a tip 403 and a base 404, and a structured portion 405 arranged between the tip 403 and the base 404,
a second set of mandrels 406 arranged opposite of and at a distance, a, from the first set of mandrels 401, wherein the mandrels of the first 401 and second 406 sets of mandrels are arranged to enter the paper tube(s) from opposite directions,
an elongated plate 407 having a surface portion 408 corresponding to and arranged to contact the structured portion 405 of the mandrel(s) 402 the first set of mandrels 401, wherein at least one of the mandrels 402 of the first set of mandrels 401 has a rotational symmetry with respect to a longitudinal axis, Z, and wherein the structured portion 405 comprises at least a first circumferential protrusion 409 defined between at least a first 410 and a second 414 recessed portion, wherein the first protrusions 409 has a first sidewall 411 extending from the first recessed portion 410 to an edge point 412 of the protrusion 409 at an angle, α, with respect to the longitudinal axis, Z of between 45 and 60 degrees and a second sidewall 413 extending from the second recessed portion 414 to the edge point 412 of the first protrusion 409 at an angle, β, of between 80 and 90 degrees.

As best illustrated in FIG. 4c, the maximum outer diameter, B, of the protrusion 409 corresponds to the diameter of the mandrel 402 of the first set of mandrels 401.

The circumferential protrusion 409 may have a maximum diameter; i.e. a total height, B, as measured from the respective end points 412 of between 2.5 and 6 mm, preferably between 3.5 and 4.0 mm.

The diameter, A, of the recessed portion 410 of the structured portion 405 of the mandrel 402 may be from 1.8 mm to 5.5 mm, e.g. from 2 to 3 mm.

At least one mandrel 402 of the first set of mandrels 401 comprises from 8 to 13 circumferential protrusions 409, preferably from 10 to 11 circumferential protrusions 409, and from 9 to 14 recessed portions 410, preferably from 11 to 12 recessed portions 410. Preferably, all mandrels 402 of the first set of mandrels 401 comprises from 8 to 13 circumferential protrusions 409.

The length, E, of the structured portion 405 may be from 15 to 25 mm, preferably from 20 to 23 mm.

The total length of the mandrel 402 may be from 200 to 280 mm, e.g. from 220 to 250 mm.

The length of the structured portion 405, as well as of the mandrel 402 may vary depending on the length of the paper straw to be manufactured.

The recessed portion 410 typically has a length, C; i.e. an extension in the longitudinal Z direction, of from 0.5 to 2 mm, preferably from 0.6 to 1.2 mm.

The protrusion 409 is defined, on each side of the longitudinal axis Z, by a first sloping sidewall 411 and a substantially straight second sidewall 413.

The first sidewall 411 (also denoted D in FIG. 4c) extends from a first recessed portion 410 to an edge point 412 of the protrusion 409 at an angle, α, of between 45 and 60 degrees with respect to the longitudinal axis, Z. A second sidewall 413 of the protrusion 409 extends from a second recessed portion 414 to the edge point 412 of the protrusion 409 at an angle, β, of between 80 and 90 degrees.

These angular dimensions of the protrusion(s) 409 are important in the formation of a paper straw being extensible and being able to move between a compressed and extended state. If the angle, β, is larger than 90 degrees, the paper straws may be teared, and subject to breaking during compression of the straws.

Paper tubes formed by the means of steps a) and b) are fed into the means 400; i.e. a corrugation machine in a manner known to the person skilled in the art.

The first set of mandrels 401 are arranged in a spaced relationship, and extend transversely with respect to the direction of a feeding track 416. The feeding track 416 moves in the direction of the arrows in FIG. 4a.

The paper tubes are fed into the corrugation machine from a hopper (not shown).

The corrugation machine may comprise means to pick up the paper tubes and arrange them on the mandrels 402.

Paper tubes are arranged on the mandrels 402 of the first set of mandrels 401; i.e. the mandrels are arranged to extend through the paper tubes. It is important that the paper tubes are loaded on the mandrels 402 in a straight configuration.

The mandrels 415 of the second set of mandrels 406 may subsequently enter the tubes from the opposite direction.

When the paper tubes have been loaded onto the mandrels 402, the feed track will move the paper tubes (arranged on the mandrels 402) towards an elongated plate 407 (illustrated in dotted lines in FIG. 4a).

The mandrels 402 rotate around the longitudinal axis, Z, of the mandrel, while the elongated plate 407 is pressed against part of the mandrels 402; at least a part comprising the structured portion 405.

The elongated plate 407 is arranged to impart a flexible portion in the paper straws. In other words, the elongated plate 407 has a surface pattern 408 which matches the structured portions 405 of the mandrels 401.

The mandrels 402 of the first set of mandrels 401 are rotably arranged on support means 417.

In embodiments, at least one mandrel 415 of the second set of mandrels 406 is arranged to be pushed against at least one oppositely arranged mandrel 402 of the first set of mandrels 401 such that a paper tube arranged on the mandrel(s) 402 of the of the first set of mandrels 401 is subject to endwise compression.

This endwise compression “closes” the flexible portion, and is performed with the mandrels 402 of the first set of mandrels 401 inside the paper tubes.

The angular dimensions of the side walls (411 and 413) of the protrusion(s) 409 are important to secure that the compression; i.e. formation of the flexible portion of the paper straw, can be performed without creating tears in the paper straw during corrugation.

The mandrels 415 of the second set of mandrels 406 are not structured, i.e. non-corrugated.

The corrugation machine 400 may comprise 30 to 50 mandrels within each sets of mandrels and is capable of “crimping” about 12000 straws per hour.

The corrugating means may rapidly and efficiently form the annular corrugations in the paper straws at high speeds in a gentle, yet robust manner, such that tearing or damage of the paper is prevented.

After the flexible portions have been formed, the paper straws are ejected out onto a conveyor (not shown). It is important that the paper straws are ejected out in a compressed state to enable bending into a u-shape.

The straws are then bent into a u-shape, and may also be sealed with a plastic envelope. This is done by conventional means (as used for plastic straws).

In FIG. 5, the means for providing an elongated tube (step a) and means for cutting the elongated tube into a plurality of shorter paper tubes (step b) are illustrated.

FIGS. 5a and 5b illustrates both the means of step a) and step b).

The means for providing an elongated paper tube (500) comprises:
a pin 501 onto which 2 to 5 plies of paper 502 are wound to form a paper tube
a heating element 503 extending between an open inlet portion 504 and an open outlet portion 505, wherein the heating element 503 is arranged at a distance, b₁, of from 10 to 50 cm, preferably from 25 to 40 cm from the tip 506 of the pin 501.

The plies of paper 502 are helically wound around the pin 501 such that the plies become overlapped and the sidewalls of the paper tubes are formed.

The speed at which the plies of paper are wound around the pin may be from about 25 meters/minute to 45 minutes per minute.

The heating element 503 is arranged along substantially the same axis as the pin 501. In embodiments, the pin 501 is set at an angle of 10-20 degrees, e.g. about 15 degrees against the heating element 503.

The formed elongated tube may thus continue, without the support of the pin 501 into the heating element 503, wherein the paper is subsequently dried.

The heating element 503 is not limited to a particular shape or construction, but is preferably a hollow element, e.g. a cylindrically shaped hollow element, wherein the elongated paper tube can be fed.

The temperature of the heating element may be in the range of from 40 to 80° C., preferably from 50 to 70° C.

If the temperature is too high, there is a risk that the paper straws become bended; i.e. “banana shaped”, which is undesirable when the paper straws are to be applied into the means for forming a flexible portion.

Upon exit from the outlet portion 505 of the heating element 503, the paper tube travels to a cutting means 507.

The cutting means 507 may be arranged at a distance, b₂, from the heating element (along substantially the same axis).

The distance, b₂, may be from 20 to 40 cm, e.g. from 25 to 35 cm.

Preferably, the means for cutting 507 the elongated paper tube into a plurality of shorter paper tubes comprises a rotatable single knife 508 as illustrated in FIG. 5c. The elongated paper tube exits from the cutting means 507 and are cut into appropriate length across the entire cross-sectional surface of the tube.

The paper tubes may be cut at an angle such that a sharper bottom surface of the straw is formed. This may be beneficial in applications involving disposable liquid boxes, where a sharper bottom can be used to puncture the sealed aperture of the box.

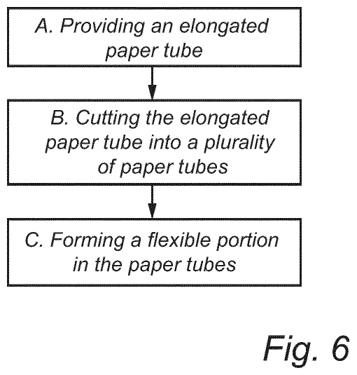

According to yet another aspect, there is provided a process for manufacturing a paper straw comprising a lower portion, an upper portion, and a flexible portion arranged between the lower and upper portions is. The process steps are schematically illustrated in FIG. 6 and comprises:

a) providing an elongated paper tube comprising a paper having a stretchability according to ISO 1924-3:2005 of at least 6% in the machine direction (MD) and at least 6% in the cross direction (CD)
b) cutting the paper tube into plurality of shorter paper tubes
c) forming a flexible portion in at least one of the paper tubes, wherein the flexible portion has a compressed state and an extended state, wherein the length of the straw is larger in the extended state compared to said compressed state.

Step a) and b) of the process may be achieved by the means of the machine equipment as described above with respect to steps a) and b) of the machine equipment of the third aspect of the present disclosure.

Step c) of the process may be achieved by means of the machine equipment described above with respect to step c) of the machine equipment of the third aspect of the present disclosure.

According to yet another aspect, the present disclosure relates to a paper straw formed by a process as described above.

According to another aspect, the present disclosure relates to the use of a paper having a stretchability according to ISO 1924-3:2005 of at least 6% in the machine direction (MD) and at least 6% in the cross direction (CD) for the manufacture of a paper straw.

The paper may have the properties as described hereinbefore.

### Examples

Comparative tests were carried out to evaluate the differences between a paper straw according to the present disclosure (paper straw A) and two reference paper straws (B and C). All paper straws comprised three plies of paper, formed by paper A, paper B, and paper C, respectively. The properties of the papers are illustrated in table 1 below.

TABLE 1
Paper properties

| | | | | TEA | TEA |
|---|---|---|---|---|---|
| | | Stretchabil- | Stretchabil- | index | index |
| | | ity in MD | ity in CD | in MD acc. | in CD acc. |
| | Basis | acc. to ISO | acc. to ISO | to ISO | to ISO |
| Paper | weight | 1924-3: | 1924-3: | 1924-3: | 1924-3: |
| straw | (g/m2) | 2005 (%) | 2005 (%) | 2005 (J/g) | 2005 (J/g) |
| Paper A | 100 | 12.8 | 11.2 | 5.7 | 3.6 |
| Paper B | 60 | 2.5 | 7.4 | 1.6 | 3.0 |
| Paper C | 120 | 2.3 | 5.6 | 1.0 | 1.4 |

The measured stretchability and TEA index in table 1 is an average of 10 paper samples.

The paper straws (A, B and C) were formed into paper tubes by means of the process described with reference to FIG. 5. In other words, a plurality of non-corrugated paper straws were initially formed. The straws were left to stand for one hour before introducing them into a corrugating machine. The corrugating machine was of the type described hereinbefore with respect to the means for forming a flexible portion in the paper tubes; i.e. as defined in claim 15 and explained with reference to FIG. 6.

With the paper straws (paper straw A) of the present disclosure, 1000 straws were introduced into the machine. For 996 of the tested straws, a flexible portion; i.e. a corrugated portion, was successfully formed in the paper tubes. Only 4 samples were rejected. All of the 996 paper straws were capable of being moved from a compressed to an extended state. Furthermore, all of the paper straws were capable of being arranged in a straight configuration and in a u-shaped configuration. None of the samples comprised any tearing or perforations in the flexible (corrugated) portion of the straw.

With paper straw B (formed from paper B), the same equipment was utilized. 20 paper non-corrugated paper straws were introduced into the same corrugating machine. In this case, the trial had to be stopped after 20 paper straws since the straws were jamming up the machine. All paper straws (comprising paper B) were rejected. 17 paper straws came out non-corrugated and only three of the paper straws contained a corrugated portion. However, all of the three corrugated paper straws had tears in the corrugations and were therefore unusable.

With paper straw C (formed from paper C), 15 straws were tested, but the testing had to be stopped to prevent damage to the machine. Out of the 15 straws tested, all straws were rejected and came out non-corrugated. The straws exiting the machine were either ripped or crushed.

To summarize, this comparative analysis demonstrates that the properties of the paper used in the paper straw is key for the ability of the straw to 1) remain resistant to breakage and collapsing during manufacturing, 2) be bent into a u-shape, and 3) be moved from a compressed into an extensible state. A paper straw of the present disclosure successfully fulfils these features, not only once, but in a repeated manner, and therefore offers a commercially attractive solution to replace plastic straws on the market.

Terms, definitions and embodiments of all aspects of the present disclosure apply mutatis mutandis to the other aspects of the present disclosure.

Even though the present disclosure has been described with reference to specific exemplifying embodiments thereof, many different alterations, modifications and the like will become apparent for those skilled in the art.

Variations to the disclosed embodiments can be understood and effected by the skilled addressee in practicing the present disclosure, from a study of the drawings, the disclosure, and the appended claims. Furthermore, in the claims, the word “comprising” does not exclude other elements or steps, and the indefinite article “a” or “an” does not exclude a plurality.

1. A paper straw (200) comprising a lower portion (201), an upper portion (202), and a flexible portion (203) arranged between said lower (201) and upper (202) portions, characterized in that said flexible portion (203) has a compressed state and an extended state; the length of said straw (200) being larger in said extended state compared to said compressed state, wherein said paper straw (200) comprises a paper having a stretchability according to ISO 1924-3:2005 of at least 6% in the machine direction (MD) and at least 6% in the cross direction (CD).

2. A paper straw (200) according to claim 1, wherein said paper straw (200) can be arranged in a straight configuration and in a curvilinear configuration, wherein in said straight configuration, said paper straw (200) has a rotational symmetry with respect to a longitudinal axis, Z, and wherein in said curvilinear configuration, the angle between the end point of said upper portion of said paper straw (200) and said longitudinal axis, Z, is from 130 to 180 degrees.

3. A paper straw (200) according to claim 1, wherein said paper straw (200) can be arranged in a straight configuration and in a substantially u-shaped configuration.

4. A paper straw (200) according to claim 1, wherein said paper has a stretchability according to ISO 1924-3:2005 of at least 9% in at least one of the machine direction (MD) and the cross direction (CD).

5. A paper straw (200) according to claim 1, wherein said paper has a tensile energy absorption (TEA) index according to ISO 1924-3:2005 of at least 3.5 J/g in the machine direction (MD) and/or at least 2.9 J/g in the cross direction (CD).

6. A paper straw (200) according to claim 1, wherein said paper straw (200) has grammage of from 250 to 500 gsm.

7. A paper straw (200) according to claim 1, wherein said paper straw (200) is formed from 2 to 5 plies of said paper.

8. A paper straw (200) according to claim 1, wherein said paper straw (200) has an outer diameter of from 3 to 7 mm.

9. A paper straw (200) according to claim 1, wherein the length of said flexible portion (203) in said extended state corresponds to from 8 to 20% of the length of said paper straw (200) in said extended state.

10. A paper straw (200) according to claim 1, wherein the length of said paper straw (200) in said extended state is at least 10% larger than the length of said paper straw (200) in said compressed state.

11. A paper straw (200) according to claim 1, wherein said flexible portion (203) comprises of from 8 to 14 corrugated sections (205), formed from the sidewalls (208) of said paper straw (200).

12. A paper straw (200) according to claim 1, wherein at least a surface of said paper straw (200) comprises a liquid impermeable coating.

13. A drinking kit (300) comprising a liquid container (301), and a paper straw (200, 302) according to claim 1.

14. A drinking kit (300) according to claim 13, wherein said paper straw (200, 302) is attached to an outer surface (304) of said liquid container (301) in a substantially u-shaped configuration.

15. A machine equipment for manufacturing a paper straw (200, 302) according to claim 1, comprising:
a) means for providing an elongated paper tube (501)
b) means for cutting (506) said elongated paper tube into a plurality of shorter paper tubes
c) means (400) for forming a flexible portion (203) in said paper tubes, characterized in that said means (400) for forming said flexible portion (203) comprises:
a first set of mandrels (401), wherein at least one mandrel (402) of said first set of mandrels (401) comprises a tip (403) and a base (404) and a structured portion (405) arranged between said tip (403) and said base (404),
a second set of mandrels (406) arranged opposite of and at a distance from said first set of mandrels (401), wherein the mandrels of said first (401) and second (406) sets of mandrels are arranged to enter said paper tube from opposite directions,
an elongated plate (407) having a surface portion (408) corresponding to and arranged to contact said structured portion (405) of said mandrel(s) (402) of said first set of mandrels (401),
wherein at least one of said mandrels (402) of said first set of mandrels (401) has a rotational symmetry with respect to a longitudinal axis, Z, and wherein said structured portion (405) comprises at least a first circumferential protrusion (409) defined between at least a first (410) and a second (414) recessed portion, wherein said first protrusions(s) (409) has a first sidewall (411) extending from said first recessed portion (410) to an edge point (412) of said first protrusion (409) at an angle, α, with respect to said longitudinal axis, Z of between 45 and 60 degrees and a second sidewall (413) extending from said second recessed portion (414) to said edge point (412) of said first protrusion (409) at an angle, β, of between 80 and 90 degrees.

16. A machine equipment according to claim 15, wherein the maximum outer diameter of said first protrusion (409) corresponds to the diameter of said mandrel (402) of said first set of mandrels (401).

17. A machine equipment according to claim 15, wherein at least one mandrel (402) of said first set of mandrels (401) comprises from 8 to 13 circumferential protrusions (409), and from 9 to 14 recessed portions (410).

18. A machine equipment according to claim 15, wherein at least one mandrel (415) of said second set of mandrels (406) is arranged to be pushed against at least one oppositely arranged mandrel (402) of said first set of mandrels (401) such that a paper tube arranged on said mandrel (402) of said first set of mandrels (401) is subject to endwise compression.

19. A machine equipment according to claim 15, wherein said means for providing an elongated paper tube (500) comprises:
a pin (501) onto which 2 to 5 plies of paper may be winded to form a paper tube, and
a heating element (503) extending between an open inlet portion (504) and an open outlet portion (505), wherein said heating element (503) is arranged at a distance, b₁, of from 10 to 50 cm from the tip (506) of said pin (501).

20. A machine equipment according to claim 15, wherein said means for cutting (507) said elongated paper tube into a plurality of shorter paper tubes comprises a rotatable single knife (508).

21. A process for manufacturing a paper straw (200, 302) comprising a lower portion (201), an upper portion (202), and a flexible portion (203) arranged between said lower (201) and upper (202) portions, said process comprising:
a) providing an elongated paper tube comprising a paper having a stretchability according to ISO 1924-3:2005 of at least 6% in the machine direction (MD) and at least 6% in the cross direction (CD)
b) cutting said paper tube into plurality of shorter paper tubes
c) forming a flexible portion (203) in at least one of said paper tubes, wherein said flexible portion (203) has a compressed state and an extended state, wherein the length of said paper straw (200, 302) is larger in said extended state compared to said compressed state.
